(19) United States
(12) Patent Application Publication
(10) Pub. No.: US 2014/0176792 A1
(43) Pub. Date: Jun. 26, 2014

(54) ELECTRONIC DEVICE FOR POSITIONING CAMERA MODULE

(71) Applicants: HON HAI PRECISION INDUSTRY CO., LTD., New Taipei (TW); Fu Tai Hua Industry (Shenzhen) Co., Ltd., Shenzhen (CN)

(72) Inventor: YAN-BANG CAO, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/961,899

(22) Filed: Aug. 8, 2013

(30) Foreign Application Priority Data
Dec. 25, 2012 (CN) 2012105694823

(51) Int. Cl. H04N 5/225

(52) U.S. Cl. CPC H04N 5/2257
USPC 348/376

(57) ABSTRACT

An electronic device for repeatable and accurate positioning of a camera after camera removal, or displacement by jarring or otherwise, is provided. The device includes a cover, a camera module, and a tray. The cover defines two spaced positioning blocks thereon. The tray includes a panel and two parallel sidewalls extending along a peripheral of the panel and perpendicular to the panel. A first adhesive sheet is utilized for adhering the tray to the cover. A second adhesive sheet is utilized for adhering the camera to the tray. The two inbuilt positioning blocks define two opposite openings. Two latching portions extend along the two parallel sidewalls and are perpendicular to the two parallel sidewalls. The two latching portions latch with the two openings, and the camera module is attachable on the panel of the tray.

### BACKGROUND

1. Technical Field

The disclosure relates to an electronic device and, more particularly, to an electronic device for positioning a camera module.

2. Description of Related Art

A camera is often attached on a cover of an electronic device via a double-sided adhesive tape. Therefore, when the electronic device is re-located or jarred, a position of the camera easily changes, which changes the old and familiar parameters for image-capturing by the camera.

Therefore, what is needed is an electronic device to overcome the described shortcoming.

### BRIEF DESCRIPTION OF THE DRAWINGS

FIG. 1 is a perspective view of an electronic device in accordance with an exemplary embodiment.

FIG. 2 is a perspective view of the electronic device of FIG. 1, but viewed from another angle.

FIG. 3 is an exploded perspective view of the electronic device of FIG. 1.

FIG. 4 is a sectional view of the electronic device of FIG. 1.

### DETAILED DESCRIPTION

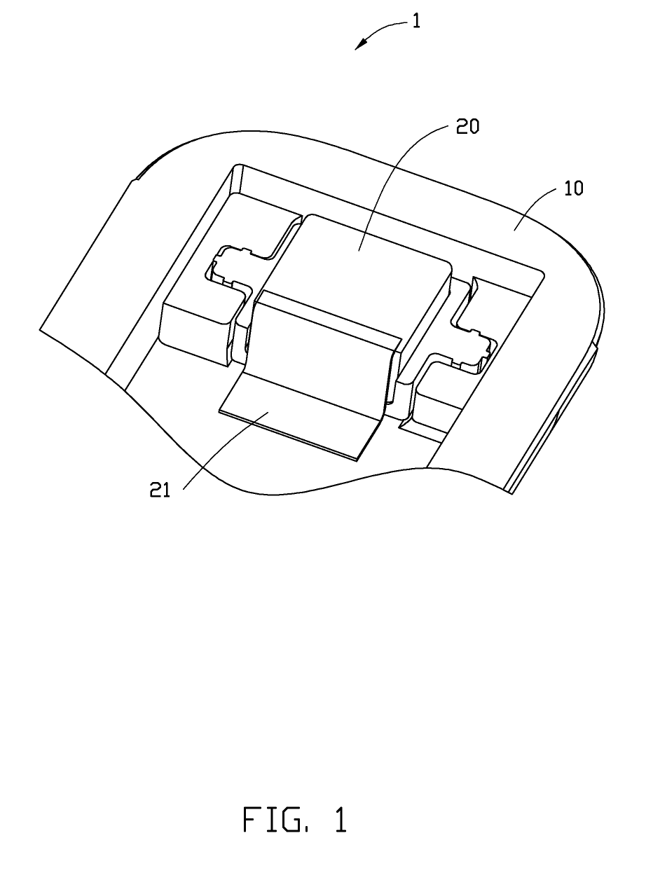

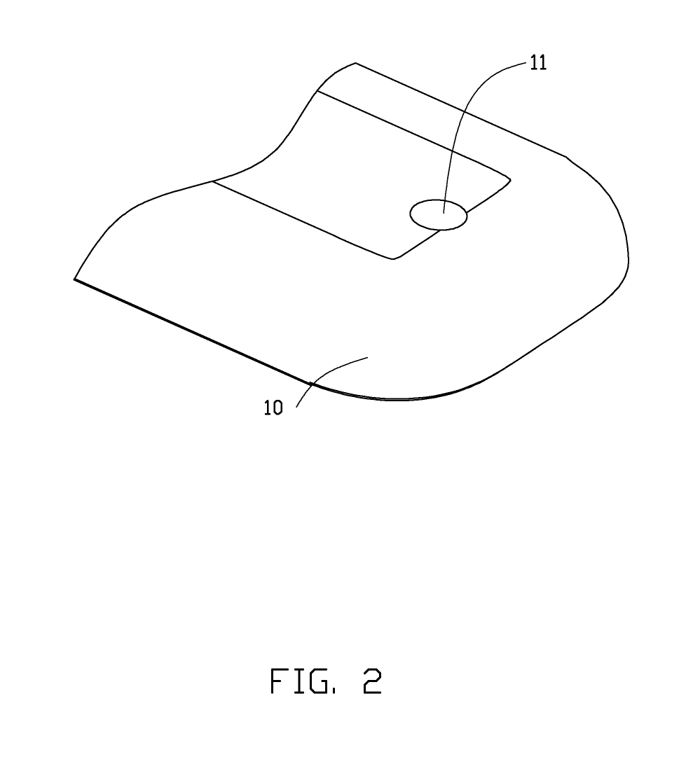

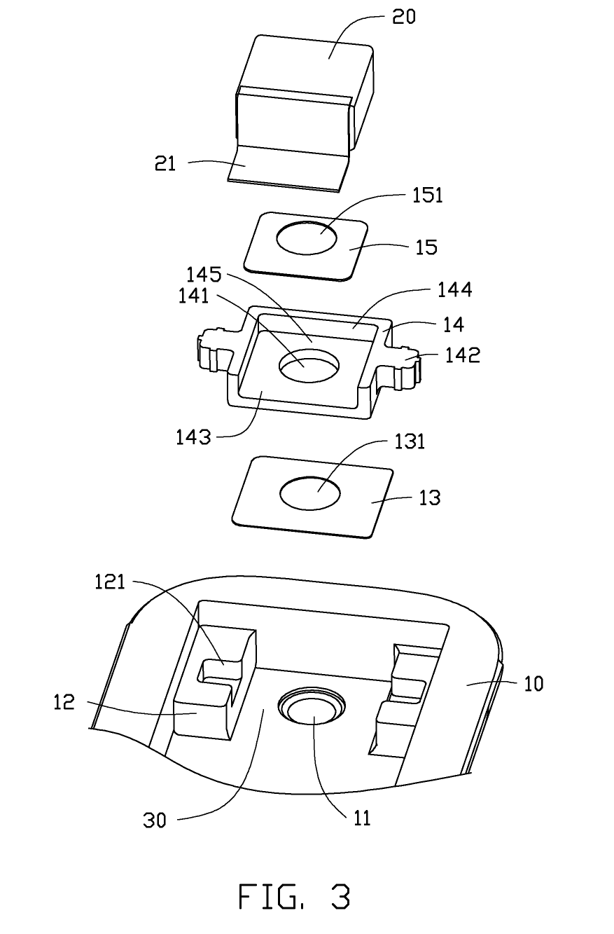

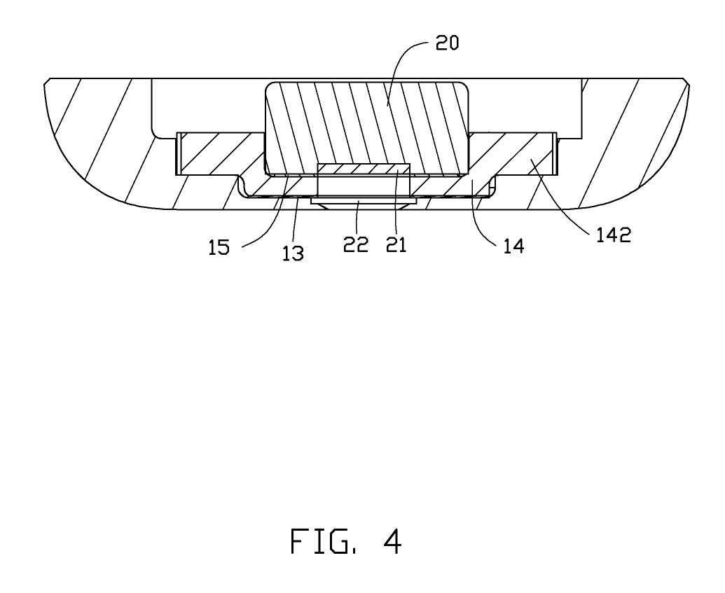

FIGS. 1-4 show an electronic device 1 of one embodiment. The electronic device 1 may be a mobile phone, a digit photo frame, or a tablet computer. The electronic device 1 includes a top cover (not shown), a circuit board (not shown), a bottom cover 10, a first adhesive sheet 13, a tray 14, a second adhesive sheet 15, and a camera module 20. A transparent lens window 11 is formed on the bottom cover 10. The camera module 20 is aligned with the transparent lens window 11. Both the first adhesive sheet 13 and the second adhesive sheet 15 are a double-sided adhesive tape. In the embodiment, a lens 22 of the camera module 20 is circular and a size of the lens 22 is the same as a size of the transparent lens window 11. Therefore, when the electronic device 1 captures an image, the camera module 20 takes a photo of the scene at the back of the electronic device 1 through the transparent lens window 11. In another embodiment, the camera 20 takes a photo of the scene in the front of the electronic device 1 through the transparent lens window 11 of the top cover.

Two spaced positioning blocks 12 are fixed on an inner surface of the bottom cover 10. Each of the two positioning blocks 12 defines an opening 121. The two openings 121 are opposite. The transparent lens window 11 is located between the two positioning blocks 12. The first adhesive sheet 13 is attached on the inner surface of the bottom cover 10 and is positioned between the two positioning blocks 12. The first adhesive sheet 13 adheres the tray 14 to the bottom cover 10. A first through hole 131, aligned with the transparent lens window 11, is defined in the first adhesive sheet 13. The first through hole 131 has the same size as the lens 22.

The tray 14 includes a panel and two parallel sidewalls perpendicularly extending from opposite ends of the panel. In the embodiment, the tray 14 includes a rectangular panel 145. Three sidewalls 144 extend along three sides of the rectangular panel 145 and are perpendicular to the rectangular panel 145. Two of the three sidewalls 144 are parallel to each other and the third sidewall is perpendicular to the two parallel sidewalls 144. Two latching portions 142 respectively extend perpendicularly from the two parallel sidewalls 144. A receiving space 143 is formed by the three sidewalls 144. A second through hole 141, aligned with the transparent lens window 11, is defined in the rectangular panel 145. The second through hole 141 has the same size as the lens 22. The rectangular panel 145 is attached on the bottom cover 10 via the first adhesive sheet 13. The two latching portions 142 are engaged with the two openings 121. Therefore, the tray 14 is stably located between the two positioning blocks 12.

The second adhesive sheet 15 is attached on the rectangular panel 145 and is positioned in the receiving space 143. The second adhesive sheet 15 adheres the camera module 20 to the tray 14. A third through hole 151, aligned with the transparent lens window 11, is defined in the second adhesive sheet 15. The third through hole 151 has the same size as the lens 22.

The lens 22 of the camera module 20 is attached on the rectangular panel 145 and the camera module 20 is attached on the three sidewalls 144 of the tray 14 and positioned in the receiving space 143. The camera module 20 is electrically connected to the circuit board via a flexible printed circuit board 21. Therefore, the camera module 20 is stably located on the tray 14.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device comprising:
a cover including two spaced positioning blocks;
a camera module;
a tray comprising a panel and two parallel sidewalls perpendicularly extending from opposite ends of the panel;
a first adhesive sheet adhering the tray to the cover; and
a second adhesive sheet adhering the camera module to the tray;
wherein the two positioning blocks respectively define two opposite openings, two latching portions respectively extend perpendicularly from the two parallel sidewalls, the two latching portions engaging with the two openings, and the camera module is attached on the panel of the tray between the sidewalls.

2. The electronic device as recited in claim 1, wherein a transparent lens window is formed on the cover, the camera module is aligned with the transparent lens window.

3. The electronic device as recited in claim 2, wherein a first through hole, is defined in the first adhesive sheet and aligned with the transparent lens window, the first through hole has the same size as that of the transparent lens window, a second through hole is defined in the panel and aligned with the transparent lens window, the second through hole has the same size as that the transparent lens window, a third through hole is defined in the second adhesive sheet and aligned with the transparent lens window, the third through hole has the same size as that of the transparent lens window.

4. The waterproof electronic device as recited in claim 1, wherein the first adhesive sheet is a double-sided adhesive tape.

5. The waterproof electronic device as recited in claim 1, wherein the second adhesive sheet is a double-sided adhesive tape.
